(19) United States
(12) Patent Application Publication
(10) Pub. No.: US 2005/0147873 A1
(43) Pub. Date: Jul. 7, 2005

(54) Battery can with rupturable safety vent and method of forming

(75) Inventor: Francis M. Malec, Waterbury, CT (US)

Correspondence Address: ARTHUR G. SCHAIER;CARMODY & TORRANCE LLP, 50 LEAVENWORTH STREET, P.O. BOX 1110, WATERBURY, CT, 06721-1110, US

(73) Assignee: Truelove & Maclean Inc., Waterbury, CT (US)

(21) Appl. No.: 10/752,836

(22) Filed: Jan. 7, 2004

(51) Int. Cl. H01M 2/12; B26D 3/08

(52) U.S. Cl. 429/56; 429/82; 83/886

(57) ABSTRACT

A battery can comprises a casing and a vent formed on a interior surface of the casing, the vent being rupturable by a condition internal to a battery cell in which the battery can is employed. The vent is a roll-formed groove disposed on the interior surface such that a weakness is defined in the casing. Upon encountering a buildup of excessive pressure in the battery cell, the vent ruptures, thereby compromising the structural integrity of the casing and relieving the pressure. A method of forming a rupturable vent in a casing of a battery cell comprises positioning the casing adjacent to a tool such that a first surface of the casing faces the tool and biasing the casing against the tool to form a groove in the first surface. A method of forming a battery can comprises forming a casing and roll-forming a rupturable vent in an interior surface of the casing.

### TECHNICAL FIELD

This invention relates in general to battery cans with rupturable safety vents and methods of forming battery cans with such vents. More particularly, this invention relates to a battery can having such a vent that is formed on an interior surface of the can.

### BACKGROUND OF THE INVENTION

Disposable and rechargeable battery cells are utilized in a wide variety of applications to provide either a main source of power or backup power to a wide variety of devices. These cells may contain acidic or alkaline electrolytic pastes in metal cans. The cans are fabricated from thin metal sheeting, such as nickel-plated steel, aluminum and stainless steel, and have zinc and carbon, or zinc and manganese oxide or other type of electrodes. The cans are typically manufactured in standard sizes such as A, AA, AAA, C, D, etc. for applications such as toys, flashlights, portable radios, and the like. They may also be manufactured in specialty sizes or in prismatic shapes for other applications such as cameras, watches, calculators, personal digital assistants, hand-held games and the like.

The cans oftentimes incorporate a joint that is designed to fail in the event that excessive pressure is built up within the electrolyte, such pressure typically being established when a recharging operation is attempted. The incorporated failure joint provides a weakness that ruptures and compromises the structural integrity of the can when the can is subjected to excessive internal pressure.

One type of failure joint is a groove that is formed on the exterior surface of the can. Such a groove is generally stamped into the exterior surface. Stamping a groove into the can, however, because of the impact forces required and the disparate fragility of the can, oftentimes results in a vent that is not uniform in depth over its length, which may provide a vent that will rupture at a pressure that is different from the pressure at which the vent is calculated to rupture. Furthermore, because the stamping operation typically requires a high impact force, significant wear of the stamping tool may be realized over relatively short production periods, thereby resulting in substantial inconsistencies in the vents in subsequently stamped cans. Moreover, stamping a groove into the exterior surface of the can mars the outer surface. If the can is made of nickel plated steel, this causes a “nickel-break,” which may provide a foothold for corrosion of the underlying metal sheeting from which the can is fabricated. The stamped groove may cause other detrimental metallurgical defects in the case of other can materials such as aluminum or stainless steel. Inconsistency in raw material physical properties may cause variation in rupture pressures.

What is needed is a battery can in which a failure joint can be incorporated that does not allow conditions to occur that detract from the appearance of the can. What is also needed is a method for providing a failure joint in a battery can such that failure joints provided in a plurality of cans produced in a high volume manufacturing process are uniform so as to allow consistent failure characteristics to be realized across production quantities.

### SUMMARY OF THE INVENTION

According to one aspect of the present invention, a battery can comprises a casing and a roll-formed vent formed preferably on an interior surface of the casing, the vent being rupturable by a condition internal to a battery cell in which the battery can is employed. In another aspect of the present invention, a method of forming a rupturable vent in a casing of a battery cell comprises positioning the casing adjacent to a tool such that a first surface of the casing faces the tool. The casing is then biased against the tool to form a groove in the first surface, the groove being configured to provide a weakness in the casing. In yet another aspect of the present invention, a method of forming a battery can comprises forming a casing and roll-forming a rupturable vent in an interior surface of the casing.

One advantage of a battery can as described above is the uniformity of the exterior surface of the can. Uniformity of the exterior surface (i.e., the lack of sharp interruptions in the surface) improves the external appearance and uniformity of the battery can, also reducing the chances that a nickel-break will form and allow corrosion to gain a foothold on the outer surface of a nickel-plated steel casing.

One advantage of the use of the roll-forming process to incorporate the vents into the battery cans is substantial uniformity of the physical attributes of the vents across production quantities. Because the physical attributes across production quantities of cans are substantially uniform, each individual battery of a particular type can be predicted to fail at substantially the same point (pressure).

Another advantage of the use of the roll-forming process is the realization of lower costs due to increased tooling life. In particular, because the roll-forming process of forming the vents is substantially less violent than the stamping operations used in prior art processes, better control of the tooling can be attained, which in turn results in extended tooling life.

Another advantage of the use of the roll-forming process is the reduction of variation in burst pressure normally caused by inconsistency in raw material physical properties. Roll-formed vents are less susceptible than stamped vents to minor fluctuations in tensile strength, elongation, hardness, and temper.

### BRIEF DESCRIPTION OF THE DRAWINGS

FIG. 1 is a perspective view of a battery can having a vent disposed on an interior surface of the casing thereof.

FIG. 2 is a sectional view of the casing showing the vent.

FIG. 3 is a perspective view of the casing undergoing a vent-forming operation.

FIG. 4 is a sectional view of the casing mounted on tooling in preparation for forming the vent.

FIG. 5 is a sectional view of the casing undergoing the vent-forming operation.

### DETAILED DESCRIPTION OF THE PREFERRED EMBODIMENT

Referring to FIG. 1, a battery can for a prismatic lithium primary battery cell is shown generally at 10. The battery can 10 comprises a casing 12 having a rupturable safety vent 14 formed or otherwise disposed on an interior surface of the casing 12. The term “vent” as used throughout the description does not mean an existing opening in the casing wall, but rather a weakened section of the casing wall that will rupture at a predetermined location under predetermined conditions. The vent 14 will rupture in response to a condition internal to the battery cell (e.g., a buildup of pressure within the cell). A top end and a bottom end of the can 10 are configured to receive suitable closure elements (e.g., an electrode cap and an electrode base) upon filling of the can 10 with an electrolyte. Although the casing 12 is illustrated hereinafter as being prismatic in shape, it should be understood that the casing is not limited to being prismatic in shape. Other shapes in which the casing may be configured include, but are not limited to, cylindrical, parallelepiped, combinations of the foregoing, and the like. Although the vent 14 is illustrated hereinafter as being linear in configuration, it should be understood that the vent is not limited to being linearly configured. Other configurations applicable to the vent include, but are not limited to, curvilinear configurations, complex configurations, arrangements of points, arrangements of dimples, combinations of the foregoing, and the like.

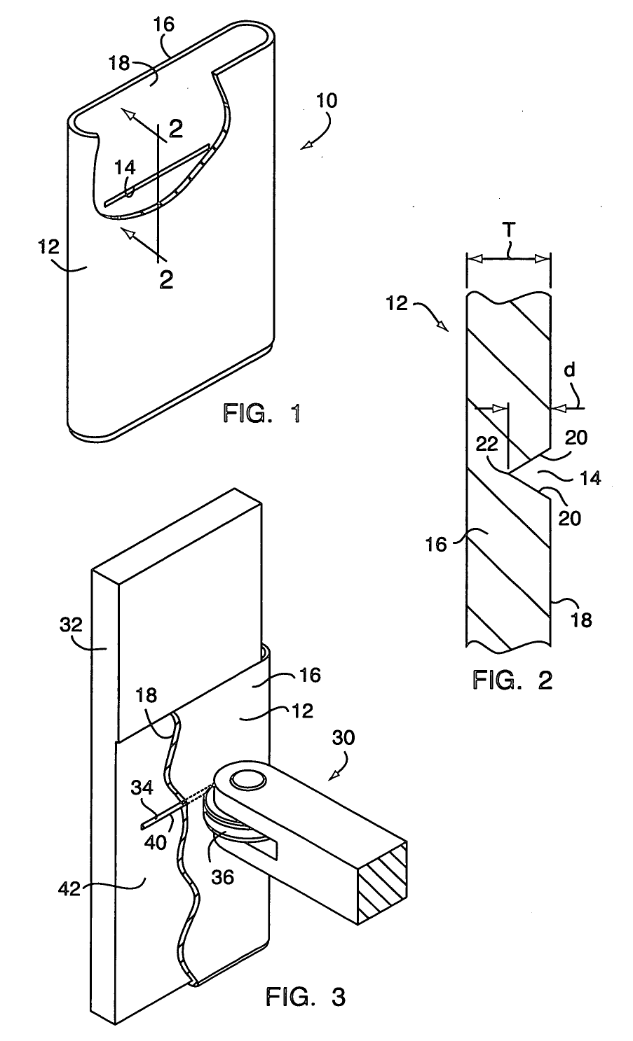

Referring now to FIG. 2, a section of a wall 16 of the casing 12 in which the vent is incorporated is shown. The vent 14 is disposed in the wall 16 at an interior surface 18 of the wall 16 such that, when the casing 12 is assembled with closure elements, the vent 14 is disposed in the interior of the battery cell. Although wall 16 is preferably a sidewall of the casing 12, it is within the purview of the present invention to locate the vent 14 in the closed base (not shown) of the casing 12. The material from which the casing 12 is fabricated is sufficiently malleable to facilitate the forming of the vent 14 by a roll forming process. Exemplary materials from which the casing 12 may be formed include, but are not limited to, steel, aluminum, combinations of the foregoing materials, and the like. A preferred material from which the casing 12 may be formed is nickel-plated cold-rolled steel.

The vent 14, as stated above, is preferably linear in configuration and extends along a portion of the interior surface 18 of the wall 16. The vent 14 is preferably formed by two opposingly-angled facing surfaces 20 that meet along a common edge 22 to define a V-shaped groove. The edge 22 of the groove defines a weakness in the wall 16 that, upon a buildup of a predetermined amount of pressure at the interior surface 18 of the casing, causes the wall 16 to rupture along the edge 22, thereby relieving the pressure at the interior surface 18.

The wall 16 is preferably dimensioned to be of a total thickness T. The force that causes the vent 14 to rupture along the edge 22 is determined to be a function of the maximum desired pressure at the interior surface 18 and the remaining wall thickness after subtracting the depth d of the vent 14 from the thickness T of the wall 16. The angle of the facing surfaces 20 may also be a factor in determining the amount of force that causes the vent 14 to rupture.

The preferred process by which a vent may be formed in a casing is a roll-forming process that is used after the casing is formed. In a roll-forming process, a casing (or at least a portion of a wall of a casing) is mounted such that one surface of the casing is positioned against or a short distance from a coin or similar tooling. The surface opposing the surface of the casing at which the coin or similar tooling is positioned is then engaged by a roller or similar device to bias the casing against the coin. Translatory pressure applied by the roller is sufficient to cause a deformation of the surface engaged by the coin. The opposing surface (engaged by the roller) is either minimally deformed or (preferably) not deformed at all. In another exemplary process by which a vent may be formed in a casing, the sheet material that comprises the casing may be roll-formed to include the vent prior to the working of the sheet material to form the casing.

Referring now to FIG. 3, the process in which the casing (or at least a portion of a wall of a casing) is roll-formed to form the vent is illustrated at 30. In the roll-forming process 30, a coin punch 32 is made to receive the casing 12. Tooling 34 on the coin punch 32 (e.g., a protrusion extending from the surface of the coin punch 32 by a distance less than the wall thickness and having a V-shaped cross sectional geometry) is utilized to form the vent upon application of translatory pressure by a roller 36.

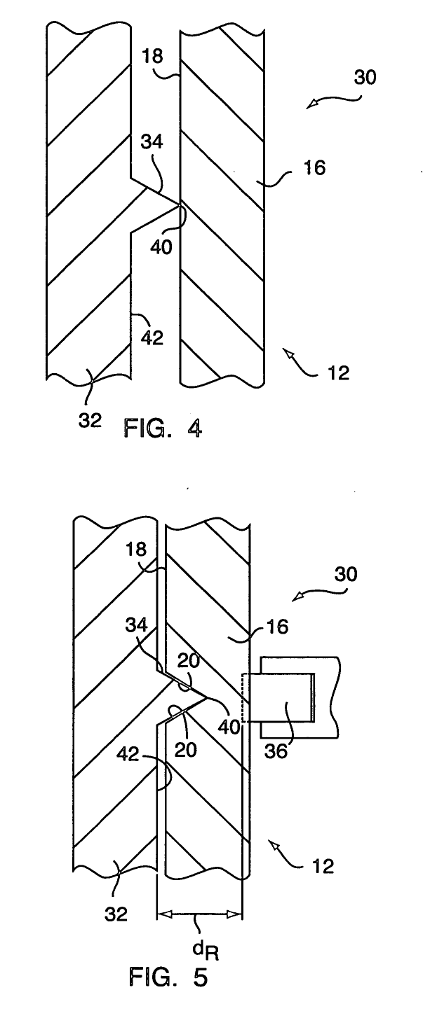

In FIGS. 4 and 5, individual steps of the roll-forming process 30 are illustrated. As is shown in FIG. 4, the casino 12 is mounted on the coin punch 32 such that the interior surface 18 of the wall 16 is adjacent to (at or near) the tooling 34. Because the material of the casing 12 is characterized by at least some degree of rigidity, the casing 12 may rest on a blade edge 40 of the tooling 34 to establish a contact pattern between the blade edge 40 and the material of the casing, but such that the material of the casing is not in direct contact with a facial surface 42 of the coin punch 32. As is shown in FIG. 5, the roller 36 is brought into engagement with the outer surface of the casing 12. Pressure is applied to the roller 36 such that the casing 12 is biased against the tooling 34 and, more particularly, against the blade edge 40 to make line contact along the blade edge 40. Preferably, the roller 36 is controlled to translate along the length of the blade edge 40 at a calculated distance from the facial surface 42 of the coin punch 32. Upon completion of the translation of the roller 36 along the blade edge 40, the roller is retracted from the coin punch 32.

Upon removal of the roll-formed casing 12 from the coin punch, the vent 14 is disposed in the interior surface thereof, as can be seen in FIG. 1. Although the vent 14 is shown as being horizontally oriented with respect to the top and bottom of the can, it should be understood that the vent 14 may be positioned to have any possible orientation.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A battery can, comprising
a casing; and
a roll-formed vent formed on a surface of said casing, said roll-formed vent being rupturable by a condition internal to a battery cell in which said battery can is employed.

2. The battery can of claim 1, wherein said casing comprises at least one wall and said roll-formed vent is formed on an interior surface of said wall.

3. The battery can of claim 1, wherein said casing is fabricated from a material selected from the group of materials consisting of steel, aluminum, and combinations of the foregoing materials.

4. The battery can of claim 1, wherein said casing is fabricated from nickel-plated cold-rolled steel.

5. The battery can of claim 1, wherein said roll-formed vent is a V-shaped groove formed on said interior surface of said casing.

6. The battery can of claim 1, wherein said roll-formed vent is formed by positioning said casing adjacent to a tool and biasing said casing against said tool.

7. A method of forming a rupturable vent in a casing of a battery cell, said method comprising:
providing a tool having a protrusion thereon;
positioning said casing adjacent to said tool such that a first surface of said casing faces said tool; and
biasing said casing against said tool with translatory pressure to form an indentation in said first surface, said indentation providing a weakness in said casing.

8. The method of claim 7, wherein said first surface of said casing comprises an interior surface of said battery cell.

9. The method of claim 7, wherein said positioning said casing adjacent to said tool comprises causing contact to be maintained between said first surface of said casing and said protrusion on said tool.

10. The method of claim 7, wherein said biasing said casing against said tool comprises applying said translatory pressure to a second surface of said casing opposing said first surface of said casing facing said tool.

11. The method of claim 10, wherein said applying translatory pressure to said second surface of said casing comprises translating a roller along said second surface.

12. The method of claim 11, wherein said translating said roller along said second surface comprises moving said roller in a pattern that corresponds to a contact pattern defined by contact maintained between said protrusion of said tool and said first surface of said casing.

13. A method of forming a battery can with a rupturable vent, said method comprising:
forming a casing having an interior surface;
roll-forming a vent in said interior surface.

14. The method of claim 13, wherein said roll-forming step comprises,
providing a tool having a protrusion thereon positioning said casing adjacent to a tool such that said interior surface faces said protrusion said tool, and
biasing said casing against said protrusion with translatory pressure.

15. The method of claim 14, wherein said biasing said casing against said protrusion comprises applying said translatory pressure to a second surface of said casing opposing said interior surface of said casing.

16. The method of claim 15, wherein said applying of said translatory pressure comprises translating a roller along said second surface of said casing.

17. The method of claim 16, wherein said translating said roller along said second surface comprises moving said roller in a pattern that corresponds to a contact pattern defined by contact maintained between said protrusion and said interior surface of said casing.
